(19) United States
(12) Patent Application Publication
(10) Pub. No.: US 2006/0139508 A1
(43) Pub. Date: Jun. 29, 2006

(54) Layout of Flat Flexible Cable of Liquid Crystal Panel Assembly

(76) Inventor: Cheng-Chun Lin, Hsin-Chu County (TW)

Correspondence Address: NORTH AMERICA INTELLECTUAL PROPERTY CORPORATION, P.O. BOX 506, MERRIFIELD, VA, 22116, US

(21) Appl. No.: 10/906,929

(22) Filed: Mar. 13, 2005

(30) Foreign Application Priority Data
Dec. 23, 2004 (TW) 093140354

(51) Int. Cl. G02F 1/1333

(52) U.S. Cl. 349/58

(57) ABSTRACT

A liquid crystal panel packaging assembly includes a rectangular carrier substrate having a longer first side and a shorter second side. A liquid crystal panel is installed on a front face of the carrier substrate. A flexible cable is wrapped from the front face of the carrier substrate along the longer first side to the back surface of the substrate, where the flat flexible cable protrudes from the shorter second side of the carrier substrate.

### BACKGROUND OF INVENTION

1. Field of the Invention

The present invention relates to a liquid crystal panel packaging assembly, and more particularly, to an improved layout of the flexible cable of a liquid crystal panel.

2. Description of the Prior Art

As is widely known, the installation of flexible cables responsible for signal transmission is an essential procedure in the assembly of liquid crystal panels. However, the conventional installation method often requires the addition of numerous auxiliary devices for achieving an integrated design, thereby resulting in higher cost to the users.

Please refer to FIG. 1. FIG. 1 is a perspective diagram showing the front view of a conventional liquid crystal panel assembly. As shown in FIG. 1, the conventional liquid crystal panel assembly includes a liquid crystal panel 10, a carrier substrate 12, and a flexible cable 14. According to the conventional method, the flexible cable 14 is protruded from a side 16 of the liquid crystal panel 10 without further rearrangement.

The conventional method often causes significant difficulty to the users when rearranging the flexible cable 14 while assembling the package substrate or other devices. Additionally, the flexible cable 14 interferes with the passage of lights. This increases the difficulty of assembling the liquid crystal panel and the optical device to one another. Furthermore, the method of allowing the flexible cable 14 to protrude from the side 16 of the liquid crystal panel increases the displacement area of the device causing more inconvenience to the users.

### SUMMARY OF INVENTION

It is therefore an objective of the present invention to provide an improved layout of the flexible cable of a liquid crystal panel for solving the above-mentioned problems.

According to the preferred embodiment of the present invention, a liquid crystal panel packaging assembly comprising: a rectangular carrier substrate comprising a longer first side and a shorter second side; a liquid crystal panel installed on the front side of the carrier substrate; and a flexible cable electrically connected to the liquid crystal panel, wrapped from the front side of the carrier substrate along the longer first side to the back surface of the carrier substrate, and protruded from the shorter second side of the carrier substrate.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a perspective diagram showing the front view of a conventional liquid crystal panel assembly.

FIG. 2 through FIG. 4 are side-view diagrams showing the protrusion of the flexible cable of a liquid crystal panel according to the present invention.

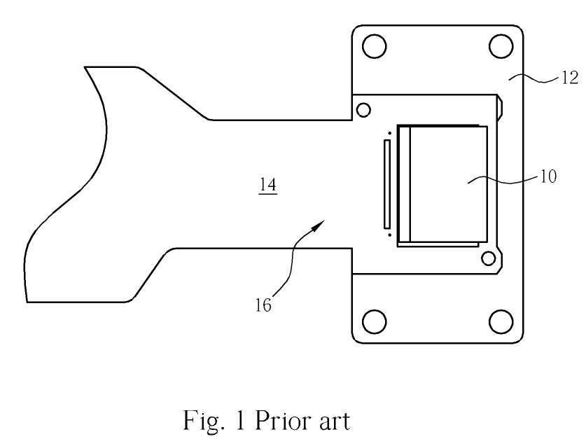

### DETAILED DESCRIPTION

According to the present invention, a layout of the flexible cable of a liquid crystal panel assembly is disclosed. By wrapping the flexible cable from the front face of the carrier substrate along the longer first side to the back surface of the substrate, and protruding the flexible cable from the shorter second side of the carrier substrate, the present invention is able to provide an unobstructed front surface for the final packaging process. Additionally, the usable area of the front surface of the panel increases, thereby preventing the flexible cable from interfering with the passage of the traveling lights.

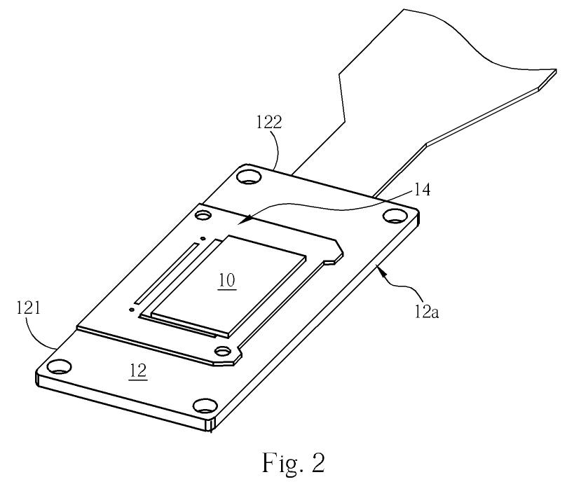

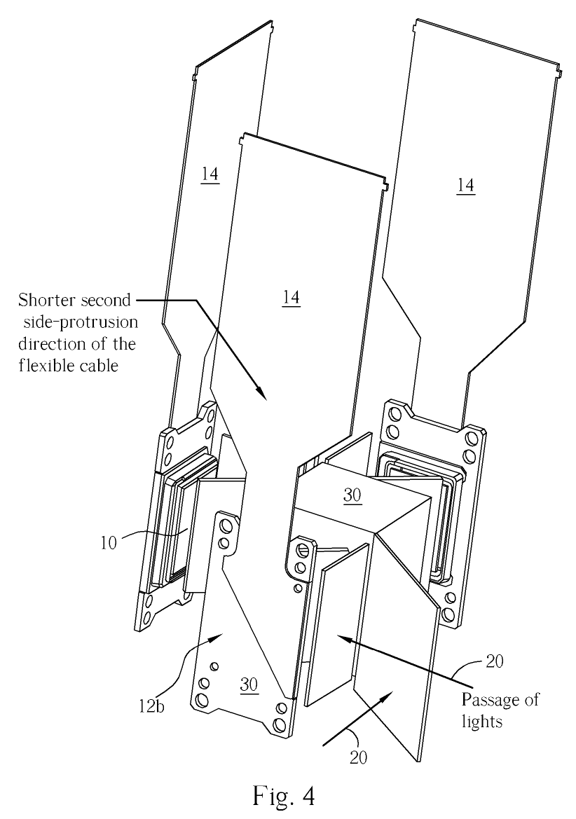

Please refer to FIG. 2 through FIG. 4. FIG. 2 through FIG. 4 are side-view diagrams showing the protrusion of the flexible cable of a liquid crystal panel according to the present invention. As shown in FIG. 2, a liquid crystal assembly includes a liquid crystal panel 10, a carrier substrate 12, and a flexible cable 14, in which the liquid crystal panel 10, such as a liquid crystal on silicon (LCOS) panel, is installed on a front side 12a of the carrier substrate 12. The carrier substrate 12 is a rectangular structure including a longer first side 121 and a shorter second side 122.

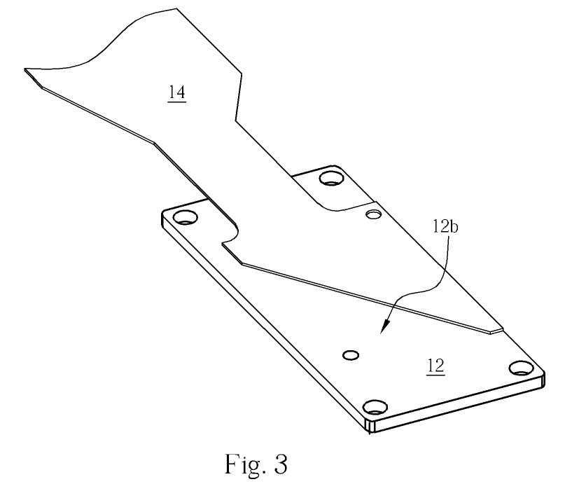

As shown in FIG. 3, the flexible cable 14 is wrapped from the front side 12a of the carrier substrate 12 along the longer first side 121 to a backside 12b of the carrier substrate 12, where the flexible cable 14 then protrudes from the shorter second side 122 of the carrier substrate 12. In contrast to the flexible cable of the conventional method that protrudes directly from the side of the substrate without further rearrangement, the protrusion design of the flexible cable 14 of the present invention is able to provide a much larger space allowance and therefore greater convenience to the users.

Additionally, a simulation and design regarding the heat transfer of the carrier substrate is conducted to ensure that the temperature of installing the flexible cable 14 on the backside 12b of the carrier substrate 12 is well maintained. Hence, additional radiating plates are no longer needed for preventing overheating problems.

Overall, the method disclosed by the present invention provides the following advantages:

(a) By wrapping the flexible cable from the front side of the carrier substrate 12 along the longer first side 121, the width of the flexible cable can be increased for accommodating more signal lines and the spacing between each signal line is also increased to prevent the lines from interfering with one other.

(b) By rearranging the flexible cable along the back side 12b of the carrier substrate 12 to protrude from the shorter second side 122, the surface of the front side 12a of the carrier substrate 12 can be rendered unobstructed, thereby facilitating the final assembly of the substrate and preventing dust from entering the image display area.

(c) The protrusion design of the present invention prevents the interference of the passage of lights.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A liquid crystal panel packaging assembly comprising:
a rectangular carrier substrate comprising a longer first side and a shorter second side;
a liquid crystal panel installed on the front side of the carrier substrate; and
a flexible cable electrically connected to the liquid crystal panel, wrapped from the front side of the carrier substrate along the longer first side to the back surface of the carrier substrate, and protruded from the shorter second side of the carrier substrate.

2. The liquid crystal panel packaging assembly of claim 1, wherein the protrusion direction of the flexible cable from the shorter second side of the carrier will not interfere with the path of traveling light beams.

3. The liquid crystal panel packaging assembly of claim 1, wherein the liquid crystal panel is a liquid crystal on silicon (LCOS) panel.
